(19) United States
(12) Patent Application Publication
(10) Pub. No.: US 2008/0270312 A1
(43) Pub. Date: Oct. 30, 2008

(54) TAXONOMY EXTENSION GENERATION AND MANAGEMENT

(75) Inventor: Michael T. Ohata, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/739,304

(22) Filed: Apr. 24, 2007

(51) Int. Cl. H04L 9/32

(52) U.S. Cl. 705/76; 705/35

(57) ABSTRACT

Systems and methods of establishing a standardized financial data model may include financial document management system. The financial document management system may receive a credential from a user and may authenticate the user based on the credential to permit access to the system. The financial document management system may further receive a financial taxonomy extension corresponding to a financial reporting item from the first user and a financial taxonomy decision regarding the received financial taxonomy extension from a taxonomy standardization system. After receiving the decision, the financial document management system may determine whether the financial taxonomy extension may be approved and/or rejected based on the received financial taxonomy decision. If approved, the financial document management system may add the received financial taxonomy extension to a financial data model.

### BACKGROUND

In today's regulatory environment, companies of all sizes in all industries face ever-increasing compliance requirements. Compliance activities regularly require reporting financial information to commercial banks, insurance issuers, tax authorities, stock exchanges, and other regulatory agencies. Most of this reporting takes place on paper with information manually entered on a form, submitted, and then keyed-in again by the receiving bank, agency and so forth. Regulators and stock exchanges have begun mandating filing in XML-based schemas to reduce manual data entry and errors and facilitate automation. For example, the U.K. tax authority, Her Majesty's Revenue and Customs, has mandated all companies file in an XML-based schema for finance and business reporting called Extensible Business Reporting Language (XBRL) by 2010. The U.S. Securities and Exchange Commission has implemented a voluntary filing program in XBRL and invested in the upgrading of their filing system to support XML data and specifically XBRL.

Unfortunately, financial and accounting software applications and other client-based tools do not offer the ability to manage XML schemas and/or easily add new XBRL tags based upon industry or company characteristics. Additionally, these applications and tools do not offer an ability to provide these XML schemas and/or XBRL tags to other users.

### SUMMARY

According to some embodiments, a financial document management system may maintain taxonomy extensions such as XBRL tags and schemas. For example, the financial document management system may receive taxonomy extensions from one or more users. The system may then determine whether to add the received taxonomy extensions to a standard financial data model. Additionally, the system may establish relationships among the taxonomy extensions. Thus, according to one embodiment, the system may provide a collaborative financial data model that may be shared amongst users.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 depicts an example configuration of a financial document management system;

FIG. 2 depicts an example embodiment of a taxonomy component;

FIG. 3 depicts a flow diagram illustrating a method of establishing a taxonomy data model according to an example embodiment;

FIG. 4 depicts a flow diagram illustrating a method of relating taxonomy extensions according to an example embodiment; and

FIG. 5 shows an exemplary computing environment in which aspects of the example embodiments may be implemented.

### DETAILED DESCRIPTION

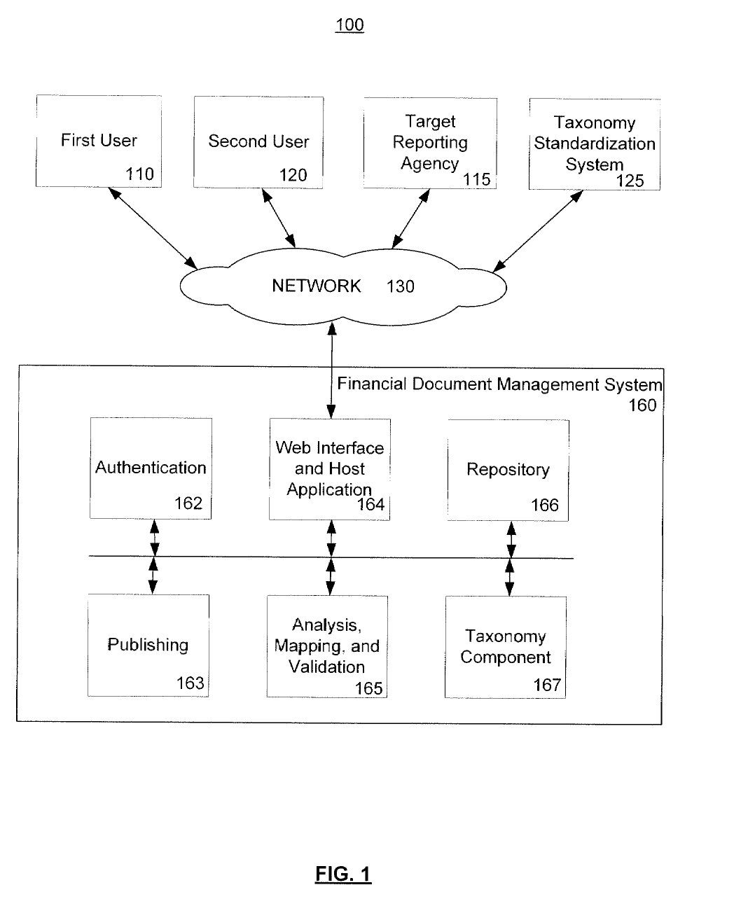

FIG. 1 depicts an example embodiment 100 of a financial document management system 160 in operative communication with a first user 110, a target reporting agency 115, a second user 120, and a taxonomy standardization component 125 via a network 130. Network 130 may be any network, such as a LAN or WAN, but preferably the network 130 represents the Internet as currently known to those of skill in the art.

Target reporting agency 115 may include any financial-based institution that may have financial reporting requirements such as government agencies, banks, and stock exchanges according to one embodiment. For example, target reporting agency 115 may include US regulatory agencies such as the Securities and Exchange Commission (SEC), and the Federal Deposit Insurance Corporation/Federal Financial Institutions Examination Council (FDIC/FFIEC) and/or foreign regulatory agencies such as the Spanish Stock Exchange Commission (CNMV—Comisión Nacional del Mercado de Valores), the German Bundesbank, the UK tax authority Her Majesty's Revenue and Customs (HMRC), the Dutch Ministries, and the Committee for European Banking Supervisors that represents all European national banking regulators. Target reporting agency 115 may also include stock Exchanges reporting entities such as KOSDAQ, and the Tokyo Stock Exchange. All of the above-mentioned reporting agencies have indicated some level of intention to incorporate electronic reporting of financial statements using Extensible Business Reporting Language (XBRL) as a standard reporting language.

In one embodiment, taxonomy standardization system 125 may be a community of experts that may review taxonomy extensions. For example, the community of experts may make a taxonomy extension decision. The taxonomy extension decision may indicate whether to add a taxonomy extension that may be provided by first user 110, for example, to a financial data model that may be shared by financial document management system 160 to other users such as second user 120. For example, first user 110 may submit a taxonomy extension to financial document management system 160. Financial document management 160 may transmit the received extension to taxonomy standardization system 125. Taxonomy standardization system 125 may issue an approved or rejected decision for the received extension. Financial document and management system 160 may then receive the decision and determine whether to add the taxonomy extension to the financial data model that may be maintained therein. If the decision may indicate approval, financial document management system 160 may add the extension to the financial data model that may be maintained therein. The extension may then be shared to other users of financial document management system 160 such as second user 120. Taxonomy standardization system 125 may also include an automated taxonomy approval system. For example, taxonomy standardization system 125 may automatically decide whether to approve or reject a taxonomy extension based on one or more criteria. In one embodiment, taxonomy standardization system 125 may include a threshold. If the taxonomy extension received by taxonomy standardization system 125 may be greater than the threshold, taxonomy standardization system 125 may automatically generate an approved decision for the taxonomy decision. The decision may be received by financial document management system 160, which will be described in more detail below.

Financial document management system 160 may include hardware components such as processors, databases, storage drives, registers, RAM memory chips, data buses, or the like and/or software components such as operating systems, database management applications, or the like. According to an example embodiment, financial document management system 160 may be a network-based server that may provide financial document conversion of financial information in a native form to a financial reporting statement in XBRL form. Additionally, financial document management system 160 may manage, share, and standardize a financial data model for a variety of industries and financial reporting requirements.

Financial document and management system 160 may include any combination of systems and sub-systems. According to one embodiment, financial document management system 160 may include an authentication module 162, a publishing module 163, a web interface and host application 164, an analysis, mapping and validation module 165, a repository module 166, and a taxonomy component 167.

Web interface and host application 164 of financial document management system 160 may interface with network 130 to provide communication between first user 110 and second user 120 and various components and features of financial document management system 160, for example. Web interface and host application 164 may provide the overall infrastructure and may be the primary consumer of the data that may be stored and published by financial document management system 160. Web interface and host application 164 may maintain its own processes, such as user management, and business rules required to make intelligent use of the data that may be provided to and by first user 110 and/or second user 120, for example. Web interface and host application 164 may also serve to interact and interface with the other functional components of financial document management system 160 including authentication module 162, repository module 166, publishing module 163, analysis, mapping and validation module 165, and taxonomy component 167.

Additionally, web interface and host application 164 may present a web interface to first user 110 and/or second user 120. For example, in the context of a prototype loan application, web interface and host application 164 may provide an interface to handle the submission of financial data, the interactive mapping of line items onto a pre-supplied taxonomy, the extension of the pre-supplied taxonomy, and customized taxonomy extensions to meet the specific needs of first user 110 and/or second user 120 and the reporting documentation standards. Web interface and host application 164 may also include an interface for establishing and sharing a new taxonomy extension based on submissions by first user 110 and/or second user 120. According to one embodiment, web interface and host application 164 may provide a user management function that may be responsible for maintaining and including the association of users with companies and assigning roles/privileges to the user based on the rights assigned to those users.

Authentication module 162 may provide a mechanism for authentication of first user 110 and/or second 120 before upload of any financial information or submission of any taxonomy extensions. Typically, users such as first user 110 and/or second user 120 may be authenticated by supplying a credential such as a username, password, or the like before services provided by financial document management system 160 may be used. Additionally, once a user has been authenticated, financial document management system 160 may choose to cache the authentication status to prevent unnecessary external authentication requests, for example. Authentication module 162 may perform an authentication itself or it may delegate authentication authority to an authentication mechanism such as a web-based authentication service. In one embodiment, authentication module 162 may be composed of bridges to various possible points of authentication such as the host application, the user's enterprise domain, or the local cache of financial document management system 160. Additionally, the passing of session-specific tokens, or other artifacts, to identify the context under which a user interacts with financial document management system 160 may be managed by the authentication module 162 in co-operation with host application 164.

Financial document management system 160 may also include an analysis, mapping and validation module 165. Analysis, mapping and validation module 165 may perform services such as validating financial data, converting financial data to commonly accepted formats including, but not limited to, XBRL, and aggregating financial data to allow richer analysis and benchmarking spanning multiple instances of financial data. Analysis, mapping and validation module 165 may also include financial models supporting the analysis and mapping functions as well as validation, including pre-defined or standard calculations, ratios or other formulae. Analysis, mapping and validation module 165 may provide the functionality needed to interpret the submission of financial data onto pre-supplied taxonomy frameworks. In one embodiment, analysis, mapping and validation module 165 may include the parsing of Excel™ spreadsheets, available through Microsoft® Corporation of Redmond, Wash. For example, Excel™ spreadsheets may be parsed into a usable object model from which financial information may be extracted. Additionally, analysis, mapping and validation module 165 may include the parsing of text files such as a tab-delimited text file, or the like. In example embodiments, such text files may include standard ASCII text files and word processing files such as Microsoft® Word™ text files. Analysis, mapping and validation module 165 may interact with taxonomy component 167 to provide mapping functionality to taxonomy extensions that may be provided by first user 110 and/or second user 120 according to an example embodiment. For example, in an example embodiment, analysis, mapping and validation module 165 may provide a financial data model of taxonomy extension. Analysis, mapping and validation module 165 may provide the financial data model to a user such as first user 110 that may supply a taxonomy extension. First user 110 may then relate the submitted taxonomy extension to a previously stored taxonomy extension that may be in the financial data model. Additionally, analysis, mapping and validation module 165 may automatically relate the submitted taxonomy extension based on a hierarchy, synonym relationship, or other key semantics, such as “x is an example label for y.” In one embodiment, a submitted taxonomy from first user 110, for example, may include “relocation expenses” this may be a sub-extension in a hierarchy for “pre-paid expense.” For example, a “relocation expenses” may be a kind of “pre-paid expense.” Analysis, mapping and validation module 165 may recognize this automatically and relate a submitted tag such as “relocation expenses” to “pre-paid expense.” Additionally, a submitted taxonomy by first user 110, for example, may be “debt” and the financial data model may already include “balance due.” Analysis, mapping and validation module 165 may recognize that “debt” may be a synonym for “balance due” such that analysis, mapping and validation module 165 may automatically relate “debt” to “balance due.” In an example embodiment, a sub-extension may be rolled into the taxonomy extension related thereto by analysis, mapping and validation module 165.

Repository module 166 may provide persistent storage for financial document management system 160. In one embodiment, repository module 166 may be an instance of SQL Server™ also available from Microsoft® Corporation. Repository module 166 may be store the financial data model and most other working records for financial document management system 160. For example, repository module 166 may store taxonomy extensions, financial data received from first user 110 and/or second user 120, or the like. In one embodiment, repository module 166 may store a standardized financial data model that may be maintained by and provided to users such as first user 110 and/or second user 120 of financial document management system 160, which will be described in more detail below. Additionally, repository module 166 may store a customized set of taxonomy extensions for each user such as first user 110. For example, a user may submit a taxonomy extension that may not be or may not become a part of the financial data model provided by financial document management system 160. Such customized taxonomy extensions submitted by, for example, first user 110 may be stored in repository module 166. In one embodiment, such customized taxonomy extensions may be indexed by a credential such as username, password, or the like that may be provided by the user to access financial document management system 160. Additionally, such customized taxonomy extensions may be secure elements in a universal financial data model. For example, repository module 166 may include a database that may include a list of taxonomy extensions customized for the user. The customized taxonomy extension list may be implemented as a tree within repository module 166 such that the credential may be the root or node of the tree. Alternatively, the customized taxonomy extension list may be organized as hierarchy with the credential being the top or first layer of the hierarchy. Under each credential in the tree or hierarchy may be, for example, each customized taxonomy extension corresponding to a particular user of financial document management system 160.

According to one embodiment, financial document management system 160 may also include publishing module 163. First user 110, second user 120, and/or processes may use publishing module 163 to manipulate, display, or manage data provided by financial document management system 160, for example. Financial document management system 160 may deliver its financial data in a variety of ways including, but not limited to, HTTP/S for simple web-based access, SMTP if users wish to send/receive emails notifications of financial data, Web Services/SOAP for a programmatic way to access the financial data, and Sharepoint for online review and collaboration of financial data. In one embodiment, XML electronic signatures may be provided as an option for the secure transmission of financial data. For example, a given user may choose to sign and encrypt a document such that an intended recipient may be able to read the document. Additionally, the intended recipient may be able to trust that the document has not been altered during transit. According to one embodiment, this encryption may be performed using standard public/private key pairs and acceptable security standards.

Financial document management system 160 may also include taxonomy component 167. Taxonomy component 167 may include any combination of hardware components such as processors, databases, storage drives, registers, cache, RAM memory chips, data buses, or the like and/or software components such as operating systems, database management applications, or the like. For example, taxonomy component 167 may gather taxonomy extension and/or definition requirements and updates from interested financial entities such as the user, the target reporting agency, the taxonomy standardization system, or the like. Additionally, taxonomy component 167 may maintain a set of taxonomy definitions, relationships, semantics, and extensions. The taxonomy definitions, relationships, semantics, and extensions may be integrated into a financial data model that may include a core set of taxonomy extensions.

According to one embodiment, first user 110 may add or submit a taxonomy extension to financial document management system 160. Such a submitted taxonomy extension may be approved and integrated with the previously stored taxonomy extensions in taxonomy component 167. The taxonomy extensions including any added taxonomy extensions may be shared with additional users including second user 120, which will be described in more detail below.

FIG. 1 illustrates sharing taxonomy extensions between two clients and may by no means be limiting, for example, additional clients may establish a relationship with financial document management system 160 such that they may contribute and share additional taxonomy extensions.

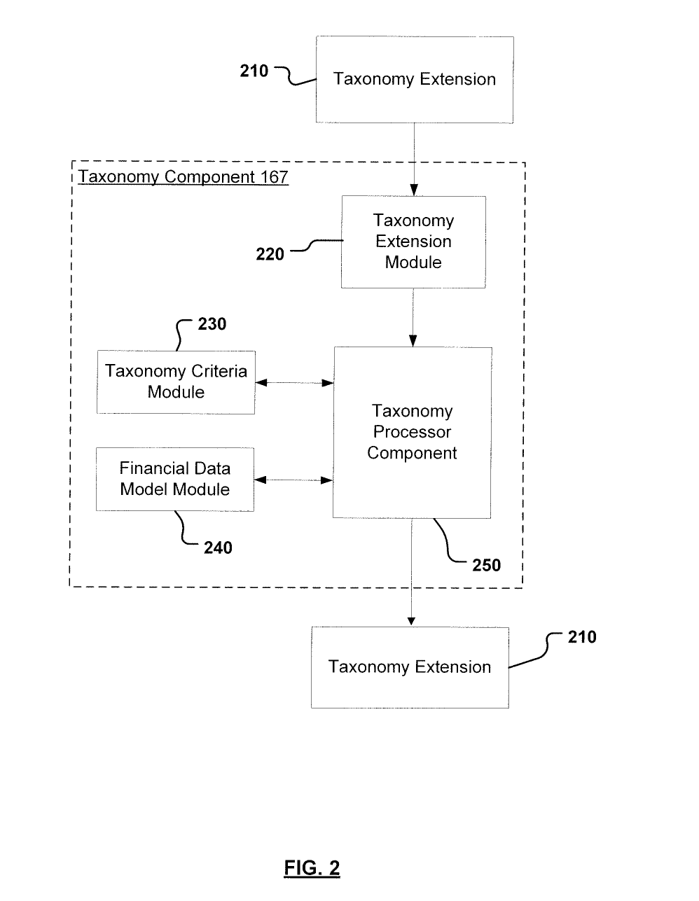

FIG. 2 depicts an example embodiment of taxonomy component 167. Taxonomy component 167 may be implemented using a variety of techniques and hardware components, including but not limited to, servers, databases, microchips, storage devices, processors, programmed modules, or the like.

As shown in FIG. 2, taxonomy component 167 may include a taxonomy extension module 220. Taxonomy extension module 220 may receive and store a taxonomy extension 210 from first user 110 and/or second user 120. Taxonomy extension module 220 may include, for example, RAM memory chips, registers, hard drives, or any other suitable hardware components designed to store data. Taxonomy extension module 220 may be in operative communication with first user 110 and/or second user 120 via web interface and host application 164, shown in FIG. 1, and may receive one or more taxonomy extensions from first user 110, for example. Taxonomy extension 210 may include, for example, a customized financial reporting tag such as new hire expense, recruiting expense, rental car travel expense, or the like. Taxonomy extension 210 may also include a taxonomy definition. In one embodiment, taxonomy extension 210 may include a set of descriptors that may describe it. For example, taxonomy extension 210 may include “travel expense.” Along with that extension, taxonomy extension 210 may include a taxonomy definition that may include descriptors such as reimbursement expense, rental car expense, or the like that may further describe the taxonomy extension “travel expense.”

According to one embodiment, taxonomy extension 210 may include a taxonomy definition and/or a relationship to a previously stored taxonomy extension or element, including semantic relationships to the previously stored taxonomies. For example, the taxonomy extension may represent a stub record or file around which additional metadata may further define the extension or element for additional use by taxonomy standardization system 125 and financial document management system 160. Additionally, financial document management system 160 may provide first user 110 a set of previously stored taxonomy extensions to which taxonomy extension 210 may be related thereto. Financial document management system 160 may relate taxonomy extension 210 to the previously stored taxonomy extensions automatically using, for example, analysis, mapping and validation module 165, described above. Additionally, taxonomy component 167 may relate taxonomy extensions 210 to previously stored taxonomy extensions using, for example, criteria or rules, which will be described in more detail below.

Taxonomy component 167 may further include taxonomy criteria module 230 adapted to store information for determining whether to add a submitted taxonomy extension to a financial data model. Taxonomy criteria module 230 may include, for example, RAM memory chips, registers, hard drives, or any other suitable hardware components designed to store data. Taxonomy criteria module 230 may include one or more rules such as, for example, a threshold indicating how many times a taxonomy extension may be submitted by a user before it may be automatically added to the taxonomy standard data model. Taxonomy criteria module 230 may further include one or more taxonomy definitions such that a taxonomy extension may be added to the standard financial data model if a submitted taxonomy such as taxonomy extension 210 may include a particular taxonomy definition. According to one embodiment, taxonomy criteria module 230 may be in operative communication with analysis, mapping and validation module 165 such that analysis, mapping, and validation module 165 may update the rules stored in taxonomy criteria module using the standard financial data model. Additionally, taxonomy criteria module 230 and/or analysis, mapping and validation module 165 may include a web-based user interface and/or application interfaces that may interact with taxonomy standardization system 125 such that community domain experts or system administrators may update rules.

In an example embodiment, taxonomy component 167 may further include a financial data model module 240 that may include a universal financial data model. Financial data model module 240 may receive and store a financial data model that may include a core set of taxonomy extensions accessible to the users of financial document management system 160 such as first user 110 and/or second user 120, shown in FIG. 1. Financial data model module 240 may include, for example, RAM memory chips, registers, hard drives, or any other suitable hardware components designed to store data. Financial data model module 240 may store and provide access to a standardized financial data model that may include a core set of taxonomy extensions. For example, financial document management system 160 may provide a universal, standard financial data model of taxonomy extensions that may be accessed by all users such as first user 110 and/or second user 120. Financial data model module 240 may store those extensions and provide them to the users such as user 110 and/or second user 120 as default taxonomy extensions. The users such as first user 110 and/or second user 120 may then submit additional taxonomy extensions such as taxonomy extension 210 that may be added to the standard financial data model that may be stored in financial data model module 240, which will be described in more detail below.

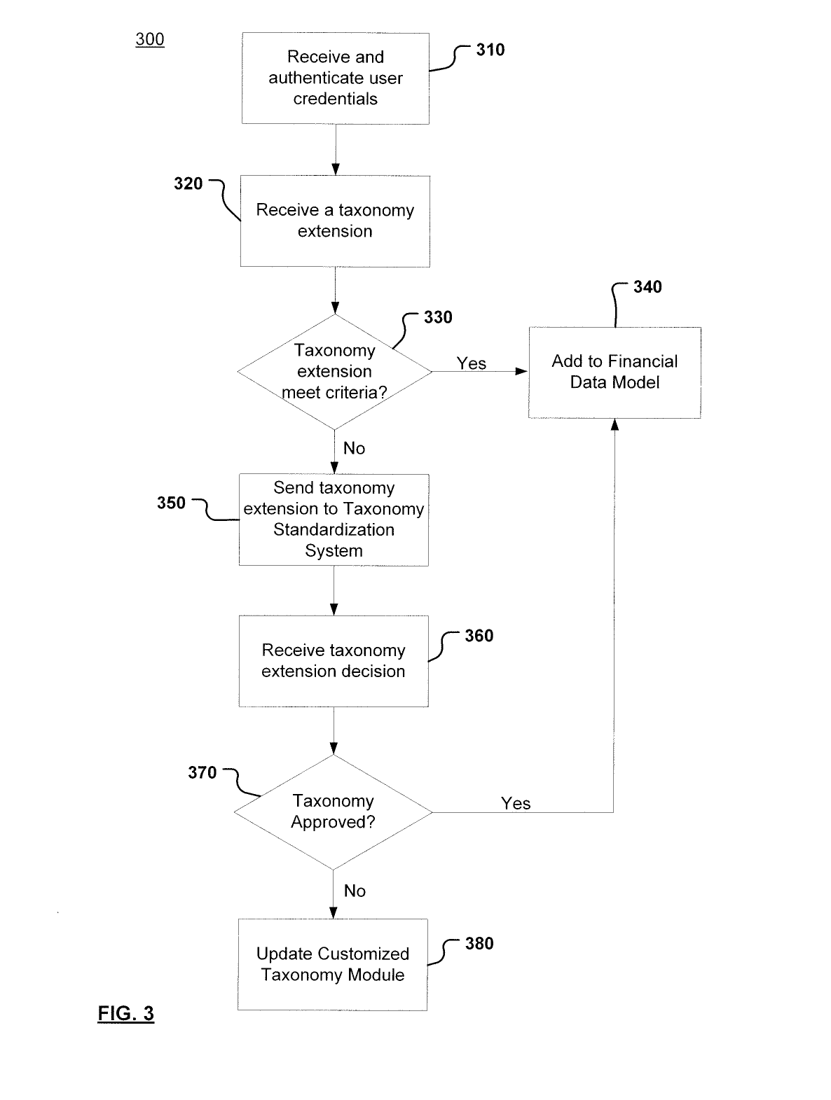

Taxonomy component 167 may further include taxonomy processor component 250. Taxonomy processor component 250 may be in operative communication with taxonomy extension module 220, taxonomy criteria module 230, and financial data model module 240, as shown in FIG. 3. Taxonomy processor component 250 may include, for example, a standard processor, a specialized processor, or the like. Taxonomy processor component 250 may engage in an initial analysis of taxonomy extension 210 by comparing taxonomy extension 210 received and stored in taxonomy module 220 with one or more rules or criteria stored in taxonomy criteria module 230, for example. If taxonomy processor component 250 determines taxonomy extension 210 may correspond to one or more rules or criteria in taxonomy criteria module 230, taxonomy processor component 250 may add the submitted taxonomy extension to the financial data model in financial data model module 240, according to one embodiment. According to an alternate embodiment, the financial data model may be stored in repository module 166, as described above. Thus, taxonomy processor component 250 may add taxonomy extension 210 to the financial data model that may be stored in repository module 166, if taxonomy processor component 250 determines taxonomy extension 210 may correspond to one or more rules or criteria in taxonomy criteria module 230.

Additionally, taxonomy processor component 250 may transmit the taxonomy extension 210 to taxonomy standardization system 125, shown in FIG. 1. Taxonomy standardization system 125 may review the taxonomy extension and may decide whether to incorporate the submitted taxonomy extension into the financial data model. Financial document management system 160 may then determine whether to add taxonomy extension 210 to the financial data model based on the decision. If the taxonomy decision may indicate approval, taxonomy processor component 250 may add taxonomy extension 210 to the financial data model that may be stored in financial data model module 240, repository module 166, or any other suitable component or subsystem in financial document management system 160.

According to one embodiment, taxonomy extension 210 may be shared with second user 120, shown in FIG. 1. For example, second user 120 may access taxonomy extension 210 if taxonomy extension 210 may be added to the financial data model. Second user 120 may search financial data model module 240 and/or repository module 166 and may use any taxonomy extension added to the financial data model by first user 110, for example. In an example embodiment, taxonomy standardization system 125 may automatically provide second user 120 with one or more suggested extensions that may already exist in the universal financial data model when second user 120 may attempt to create a custom extension.

FIG. 3 depicts a flow diagram illustrating a method of establishing a taxonomy data model according to an example embodiment. According to one embodiment, method 300 of FIG. 3 may represent actions taken by one or more of the components of the systems described above in FIGS. 1 and 2. At 310, a financial document management system may receive a taxonomy extension from a user. The financial document management system may include any combination of hardware components such as processors, databases, storage drives, registers, RAM memory chips, data buses, or the like and/or software components such as operating systems, database management applications, or the like. For example, the financial document management system may be a network-based server that may provide financial document conversion of financial information in native form to a financial reporting statement and may manage, share, and standardize a taxonomy data model for a variety of industries and financial reporting requirements. The financial document management system may be in communication with a user via a network. The user may log onto the financial document management system by supplying a credential such as a username, a password, or the like. The user may then be authenticated by the financial document management system and/or an externally based authentication system using, for example, tokens to verify the identify of the user. According to one embodiment, the financial document management system may include a taxonomy component. The taxonomy component may include a taxonomy extension module that may receive and store the taxonomy extension that may be provided by the user after authentication.

After receiving the taxonomy extension, at step 320, the financial document management system may compare the received taxonomy extension with criteria such as rules, semantic relationship definitions, or the like. For example, the taxonomy component of the financial document management system may include a taxonomy criteria module that may be adapted to store information for determining whether to add a taxonomy extension to a taxonomy data model. The taxonomy criteria module may include, for example, RAM memory chips, registers, hard drives, or any other suitable hardware components designed to store data. The taxonomy criteria module may include one or more rules such as, for example, a threshold indicating how many times a taxonomy extension may be submitted by a user before it may be automatically added to the taxonomy standard data model.

The taxonomy component may further include a taxonomy processor component in operative communication with the taxonomy module and the taxonomy criteria module. The taxonomy processor may include, for example, a standard processor, a specialized processor, or the like. The taxonomy processor component may engage in an initial analysis of taxonomy extension received from a user, at 310, by comparing the taxonomy extension that may be received and stored in the taxonomy extension module with the rules stored in taxonomy criteria module, for example.

At 330, if the received taxonomy extension corresponds to one or more of the rules or criteria in the taxonomy criteria module, the received taxonomy extension may be added to the financial data model that may be maintained by the financial document management system. Thus, according to one embodiment, the received taxonomy extension may become an extension of the data model maintained and provided to users of the financial document management system automatically using one or more rules. For example, the extension may become part of a universal financial data model.

At 330, if the received taxonomy extension does not correspond to one or more of the rules or criteria in the taxonomy criteria module, the taxonomy extension may be sent to a taxonomy standardization system. In one embodiment, the taxonomy standardization system may be a community of experts that may review the taxonomy extension. For example, the community of experts may make a taxonomy extension decision such as approved or rejected. The taxonomy extension decision may indicate whether to add a taxonomy extension to a financial data model that may be provided by the financial document management system. The taxonomy standardization system may also include an automated taxonomy approval system. For example, taxonomy standardization system may automatically decide whether to approve or reject a taxonomy extension based on one or more criteria. In one embodiment, the taxonomy standardization system may include a threshold such that if the number of times the taxonomy extension has been received by the taxonomy standardization system may be greater than the threshold, the taxonomy standardization system may automatically generate an approved decision for the taxonomy decision.

Then, at 360, the financial document management system may receive the decision from the taxonomy standardization system. For example, the financial document management system may receive the decision provided by the taxonomy standardization system on whether to approve or reject the taxonomy extension provided by the user as an extension in the taxonomy data model.

At 370, if the taxonomy standardization system approved the taxonomy extension, the received taxonomy extension may be added to the taxonomy data model that may be maintained by the financial document management system, at 340. Thus, according to one embodiment, the received taxonomy extension may become an extension of the data model maintained and provided to users by the financial document management system after being reviewed by the taxonomy standardization system.

At 370, if the taxonomy standardization system did not approve the taxonomy extension, at 380, a set of customized taxonomy extensions corresponding to the user providing the taxonomy extension may be updated according to one embodiment. For example, financial document management system may include a set of taxonomy extensions unique to each user. Such a set of extensions may be updated even if the taxonomy extension may not become an extension in the taxonomy data model by, for example, adding the taxonomy extension not approved, at 370, to the set of customized taxonomy extensions at 380. In one embodiment, both the set of customized taxonomy extensions and the universal financial data model may be displayed to the user.

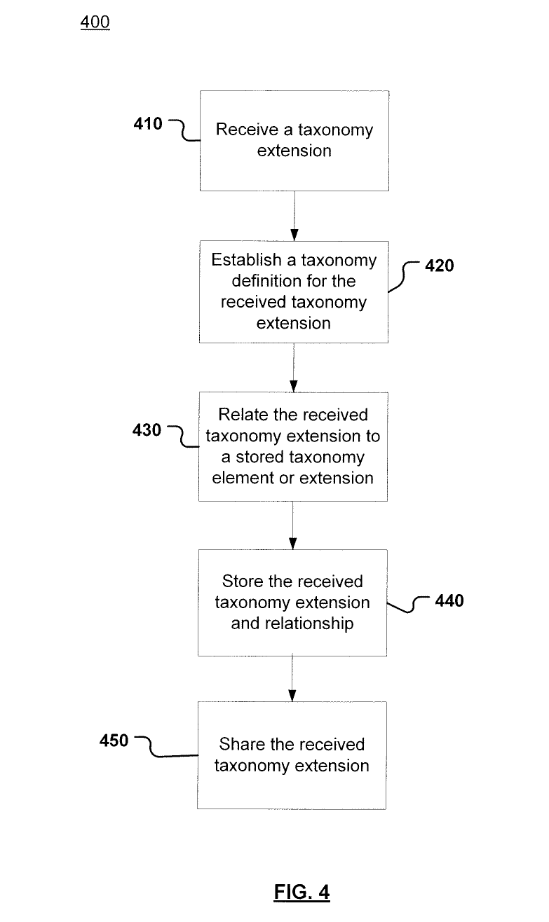

FIG. 4 depicts a flow diagram illustrating a method of relating taxonomy extensions according to an example embodiment. According to one embodiment, method 400 of FIG. 4 may represent actions taken by one or more of the components of the systems described above in FIGS. 1 and 2. At 410, a financial document management system may receive a taxonomy extension, for example, from a user. The financial document management system may include any combination of hardware components such as processors, databases, storage drives, registers, RAM memory chips, data buses, or the like and/or software components such as operating systems, database management applications, or the like. For example, the financial document management system may be a network-based server that may provide financial document conversion of financial information in native form to a financial reporting statement and may manage, share, and standardize a taxonomy data model for a variety of industries and financial reporting requirements. The financial document management system may be in communication with a user via a network. The user may log onto the financial document management system by supplying a credential such as a username, a password, or the like. The user may then be authenticated by the financial document management system and/or an externally based authentication system using, for example, tokens to verify the identify of the user.

After receiving the taxonomy extension, at 420, the taxonomy definition may be established. The received taxonomy extension may include a taxonomy definition. For example, the user may provide a definition or context corresponding to the taxonomy extension he or she may provide such as a set of descriptors that may describe the extension, including semantic relationship to other elements. According to one embodiment, after receiving the taxonomy extension, the financial document management system may provide the user with a list of the currently available taxonomy extensions and definitions. The user may use these definitions to help establish a definition for the submitted taxonomy extension. Additionally, the user may select extensions similar to the submitted taxonomy extension and those definitions may be automatically tied to the submitted taxonomy extension by the financial document management system.

At 430, the financial document management system may then relate the received taxonomy extension to a stored taxonomy extension or an existing standard element. For example, the financial document management system may include an analysis and mapping module. The analysis and mapping module may automatically relate an extension based on the taxonomy definition provided by the user. Alternatively, the user may manually relate the taxonomy extension. For example, the user may be provided a list of taxonomy elements and/or extensions and corresponding taxonomy definitions currently provided by the financial document management system. The user may then select one or more taxonomy elements and/or extensions provided by the financial document management system to which to relate to the submitted taxonomy extension.

At 440, the received taxonomy extension including its corresponding definition and relationship to other taxonomy extensions may be stored by the financial document management system. For example, the received taxonomy extension may be integrated in a financial data model that may be provided by and stored in the financial document management system. Alternatively, the received taxonomy module may be integrated in a set of customized taxonomy extensions unique to each user that may be stored and provided by the financial document system. For example, if the received taxonomy extension may not be approved to become a part of the financial data model, the received taxonomy extension may be stored by the financial document management system in a repository module that includes a customized set of taxonomies corresponding to each user. According to one embodiment, the customized set of taxonomies that may be stored in the repository module may be indexed by the credential such as username, password, or the like that may be provided by the user to access the financial document management system. For example, the repository module may include a database that may include a list taxonomy extensions customized for the user. The customized taxonomy extension list may be implemented as a tree within the repository module such that the credential may be the root of the tree. Alternatively, the customized taxonomy extension list may be organized as hierarchy with the credential being the top of the hierarchy. Under each credential in the tree or hierarchy may be, for example, each customized taxonomy extension corresponding to a user of the financial document management system.

At 450, the taxonomy extension may be shared by the financial document system. For example, additional users may access the received taxonomy extension and use that extension with their own financial statement data. According to one embodiment, the financial document management system may provide a financial data model that may be searched. For example, a user may search the financial data model for taxonomy extensions that may be used to describe or identify his or her financial statement data that may be managed by the financial document management system. Additionally, according to one embodiment, taxonomy standardization system 125 may suggest extensions to the user based on the user's previous actions, for example, to define new extensions.

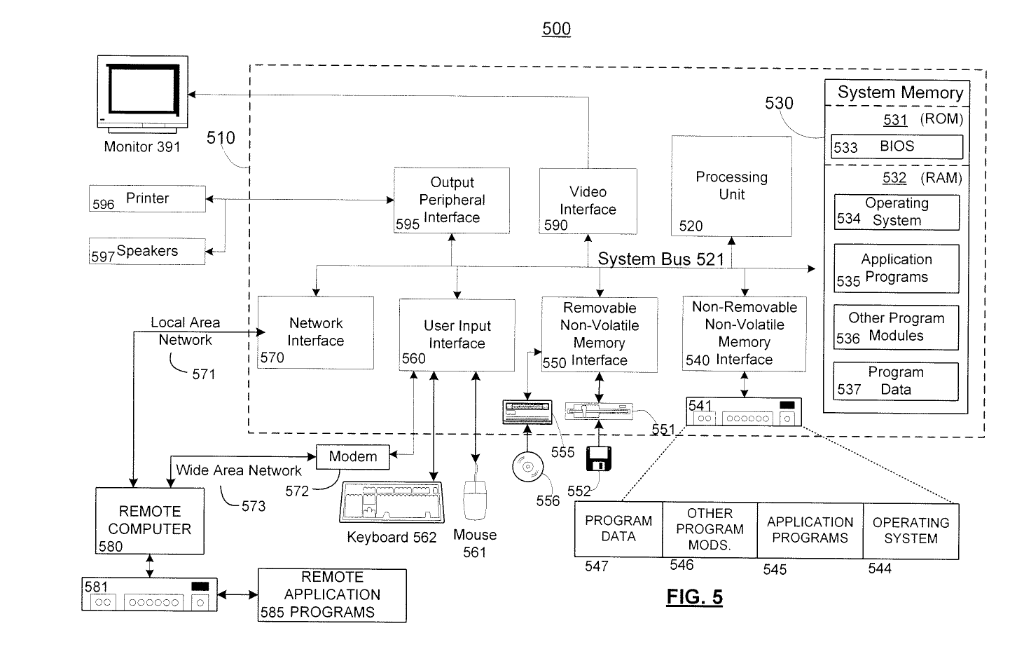

FIG. 5 shows an exemplary computing environment in which aspects of the example embodiments may be implemented. Computing system environment 500 is only one example of a suitable computing environment and is not intended to suggest any limitation as to the scope of use or functionality of the described example embodiments. Neither should computing environment 500 be interpreted as having any dependency or requirement relating to any one or combination of components illustrated in exemplary computing environment 500.

The example embodiments are operational with numerous other general purpose or special purpose computing system environments or configurations. Examples of well known computing systems, environments, and/or configurations that may be suitable for use with the example embodiments include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The example embodiments may be described in the general context of computer-executable instructions, such as program modules, being executed by a computer. Generally, program modules include routines, programs, objects, components, data structures, etc. that perform particular tasks or implement particular abstract data types. The example embodiments also may be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing the example embodiments includes a general purpose computing device in the form of a computer 510. Components of computer 510 may include, but are not limited to, a processing unit 520, a system memory 530, and a system bus 521 that couples various system components including the system memory to processing unit 520. Processing unit 520 may represent multiple logical processing units such as those supported on a multi-threaded processor. System bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). System bus 521 may also be implemented as a point-to-point connection, switching fabric, or the like, among the communicating devices.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

System memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

Computer 510 may also include other removable/non-removable, volatile/nonvolatile computer storage media. By way of example only, FIG. 6 illustrates a hard disk drive 540 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Hard disk drive 541 is typically connected to system bus 521 through a non-removable memory interface such as interface 540, and magnetic disk drive 551 and optical disk drive 555 are typically connected to system bus 521 by a removable memory interface, such as interface 550.

The drives and their associated computer storage media discussed above and illustrated in FIG. 5, provide storage of computer readable instructions, data structures, program modules and other data for computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to processing unit 520 through a user input interface 560 that is coupled to the system bus, but may be connected by other interface and bus structures, such as a parallel port, game port or a universal serial bus (USB). A monitor 591 or other type of display device is also connected to system bus 521 via an interface, such as a video interface 590. In addition to the monitor, computers may also include other peripheral output devices such as speakers 597 and printer 596, which may be connected through an output peripheral interface 595.

Computer 510 may operate in a networked environment using logical connections to one or more remote computers, such as a remote computer 580. Remote computer 580 may be a personal computer, a server, a router, a network PC, a peer device or other common network node, and typically includes many or all of the elements described above relative to computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, computer 510 is connected to LAN 571 through a network interface or adapter 570. When used in a WAN networking environment, computer 510 typically includes a modem 572 or other means for establishing communications over WAN 573, such as the Internet. Modem 572, which may be internal or external, may be connected to system bus 521 via user input interface 560, or other appropriate mechanism. In a networked environment, program modules depicted relative to computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of establishing a standardized financial data model, the method comprising:
receiving a credential from a first user and authenticating the first user based on the credential to permit access;
receiving a financial taxonomy extension corresponding to a financial reporting item from the first user;
receiving a financial taxonomy decision regarding the received financial taxonomy extension from a taxonomy standardization system;
determining whether the financial taxonomy extension is approved based on the received financial taxonomy decision;
adding the received financial taxonomy extension to a financial data model if, based on the received financial taxonomy decision, the received financial taxonomy decision is approved; and
displaying the financial data model to the user.

2. The method of claim 1, further comprising adding the received financial taxonomy extension to a customized taxonomy module corresponding to the first user if, based on the determination, the received financial taxonomy extension is not approved.

3. The method of claim 1, further comprising:
comparing the received financial taxonomy extension to one or more criteria; and
adding the received financial taxonomy extension to the financial data model if, based on the comparison, the received financial taxonomy extension matches the criteria.

4. The method of claim 3, wherein the criteria includes at least one of the following: a threshold of requests for the received financial taxonomy extensions and a taxonomy definition

5. The method of claim 1, further comprising:
establishing a financial taxonomy definition corresponding to the received financial taxonomy extension;
relating the received financial taxonomy extension to at least one of a stored taxonomy element and a stored taxonomy extension based on the financial taxonomy definition to establish a relationship between the received financial taxonomy extension and the at least one of the stored taxonomy element and the stored taxonomy extension; and
storing the received financial taxonomy extension and the relationship.

6. The method of claim 5, wherein the taxonomy definition includes at least one descriptor that describes the received taxonomy extension.

7. The method of claim 5, wherein the received taxonomy extension is shared to at least a second user.

8. A server computer system for establishing a standardized financial data model, the system comprising:
a communications interface to a network, the communications interface accepting login attempts by a user from a remote network computer;
at least one storage area for program code and data;
a processor for executing the program code, wherein the program code directs the server computer to performs the functions comprising:
receiving a credential from a first user and authenticates the first user based on the credential to permit access;
receiving a financial taxonomy extension corresponding to a financial reporting item from the first user;
comparing the received financial taxonomy extension to one or more criteria; and
adding the received financial taxonomy extension to a financial data model if, based on the comparison, the received financial taxonomy extension matches the criteria.

9. The system of claim 8, wherein the criteria includes at least one of the following: a threshold of requests for the received financial taxonomy extensions and a taxonomy definition.

10. The system of claim 8, wherein the processor further performs the functions comprising:
receiving a financial taxonomy decision regarding the received financial taxonomy extension from a taxonomy standardization system;
determining whether the financial taxonomy extension is approved based on the received financial taxonomy decision; and
adding the received financial taxonomy extension to the financial data model if, based on the received financial taxonomy decision, the received financial taxonomy decision is approved.

11. The system of claim 10, wherein the received financial taxonomy extension is added to a customized taxonomy module corresponding to the first user if, based on the determination, the received financial taxonomy extension is not approved.

12. The system of claim 8, wherein the processor further performs the functions comprising:
establishing a financial taxonomy definition corresponding to the received financial taxonomy extension;
relating the received financial taxonomy extension to at least one of a stored taxonomy element and a stored taxonomy extension based on the financial taxonomy definition to establish a relationship between the received financial taxonomy extension and the stored taxonomy extension; and
storing the received financial taxonomy extension and the relationship.

13. The system of claim 12, wherein the received taxonomy extension is shared to at least a second user.

14. A computer-readable storage medium having computer-readable instructions for establishing relationships between financial taxonomy extensions, the computer-readable instructions comprising instructions for:
receiving a credential from a first user and authenticating the first user based on the credential to permit access;
receiving a financial taxonomy extension corresponding to a financial reporting item from the first user;
establishing a financial taxonomy definition corresponding to the received financial taxonomy extension;
relating the received financial taxonomy extension to at least one of a stored taxonomy element and a stored taxonomy extension based on the financial taxonomy definition to establish a relationship between the received financial taxonomy extension and the stored taxonomy extension; and
storing the received financial taxonomy extension and the relationship.

15. The computer-readable storage medium of claim 14, wherein the taxonomy definition includes at least one descriptor that describes the received taxonomy extension

16. The computer-readable storage medium of claim 14, wherein the received taxonomy extension is shared to at least a second user.

17. The computer-readable storage medium of claim 14, further comprising instructions for:
receiving a financial taxonomy decision regarding the received financial taxonomy extension from a taxonomy standardization system;
determining whether the financial taxonomy extension is approved based on the received financial taxonomy decision; and
adding the received financial taxonomy extension to a financial data model if, based on the received financial taxonomy decision, the received financial taxonomy decision is approved.

18. The computer-readable storage medium of claim 15, wherein the received financial taxonomy extension is added to a customized taxonomy module corresponding to the first user if, based on the determination, the received financial taxonomy extension is not approved.

19. The computer-readable storage medium of claim 14, further comprising instructions for:
comparing the received financial taxonomy extension to one or more criteria; and
adding the received financial taxonomy extension to the financial data model if, based on the comparison, the received financial taxonomy extension matches the criteria.

20. The computer-readable storage medium of claim 19, wherein the criteria includes at least one of the following: a threshold of requests for the received financial taxonomy extensions and a taxonomy definition.
